(19) United States
(12) Patent Application Publication
(10) Pub. No.: US 2011/0187633 A1
(43) Pub. Date: Aug. 4, 2011

(54) DISPLAY CAPABLE OF RESTRAINING RIPPLE OF COMMON VOLTAGE

(75) Inventors: Yu-Ting Huang, Nantou County (TW); Yi-Suei Liao, Kaohsiung City (TW); Pei-Chen Chan, Hsinchu City (TW)

(73) Assignee: AU OPTRONICS CORPORATION, Hsinchu (TW)

(21) Appl. No.: 12/773,851

(22) Filed: May 5, 2010

(30) Foreign Application Priority Data
Feb. 3, 2010 (TW) 99103186

(51) Int. Cl. G09G 3/36

(52) U.S. Cl. 345/94

(57) ABSTRACT

A display including a display panel and a compensation circuit is provided. The display panel includes a plurality of common lines for transmitting a common voltage; a plurality of scan lines; a plurality of data lines disposed substantially perpendicular to the scan lines; a plurality of pixels arranged in an array and each electrically connected to the corresponding data line, scan line, and common line; and a sensing line crossing over at least one first data line among the data lines. A parasitic capacitor is formed between the first data line and the sensing line. The compensation circuit is electrically connected to the sensing line and the common lines. The compensation circuit generates a compensation signal for the common lines according to a coupling signal induced by the parasitic capacitor between the first data line and the sensing line so as to restrain ripple of the common voltage.

### CROSS-REFERENCE TO RELATED APPLICATION

This application claims the priority benefit of Taiwan application serial no. 99103186, filed on Feb. 3, 2010. The entirety the above-mentioned patent application is hereby incorporated by reference herein and made a part of specification.

### BACKGROUND OF THE INVENTION

1. Field of the Invention

The present invention generally relates to a flat panel display, and more particularly, to a liquid crystal display (LCD).

2. Description of Related Art

The sizes of electronic parts have been reduced all the time in order to meet the requirement of today's high-speed, high-performance, small-size, and light-weight electronic products. Besides, various portable electronic devices, such as notebook computers, cell phones, electronic dictionaries, personal digital assistants (PDAs), web pads, and tablet personal computers (tablet PCs), have become very popular. In order to meet the compact sizes of today's portable electronic products, liquid crystal display (LCD) panels with high space efficiency, high image quality, low power consumption, and zero radiation have been broadly applied as image display panels of these portable electronic devices. In recent years, display manufacturers have dedicated themselves to the reduction of manufacturing cost and power consumption of LCD panels so as to further promote their products with LCD panels and meet the growing trend of energy conservation. Accordingly, a technique for reducing the number of data driving chips has been provided, wherein the layout of a pixel array is changed so that less number of data driving chips is used.

FIG. 1A is a diagram of a conventional LCD panel in a tri-gate driving structure. Referring to FIG. 1A, the LCD panel 100 has a plurality of pixel units U arranged in an array. Each of the pixel units U includes pixels R, G, and B sequentially arranged along the column direction. Each of the pixels R, G, and B is electrically connected to the corresponding scan line GL and data line DL through the corresponding active device (i.e., thin film transistor (TFT)). As shown in FIG. 1A, the active devices electrically connected to the same data line are alternatively arranged at both sides of the data line along the column direction, and the pixels for writing data signals through the same data line are arranged in a zigzag pattern. Accordingly, data driving chips bonded to the LCD panel 100 can drive the LCD panel 100 through column inversion, so that the power consumption can be reduced.

However, when the (for example, twist nematic (TN)) LCD panel 100 is driven through column inversion and accordingly presents an alternate black and white pattern or presents a vertical stripe pattern (i.e. V stripe pattern), since the positive data signal (D+) and the negative data signal (D−) transmitted on adjacent two data lines have the same coupling direction and parasitic capacitors exist between data lines and scan lines and between the scan lines and common lines for transmitting a common voltage Vcom in the pixel array, coupling signals are induced by the parasitic capacitors between the data lines and the scan lines and between the scan lines and the common lines when data signals received by the data lines are in transient. As a result, the ripple (as shown in FIG. 1B) is produced on the common voltage in response to such coupling signals, and accordingly the quality of a displayed image is affected.

### SUMMARY OF THE INVENTION

Accordingly, the present invention is directed to a display that can restrain the ripple of a common voltage and accordingly offer improved image display quality.

The present invention provides a display including a display panel and a compensation circuit. The display panel includes a plurality of common lines for transmitting a common voltage, a plurality of scan lines, a plurality of data lines disposed substantially perpendicular to the scan lines, a plurality of pixels arranged in an array and each electrically connected to the corresponding data line, scan line, and common line, and a sensing line crossing over at least one first data line among the data lines. A parasitic capacitor is formed between the first data line and the sensing line. The compensation circuit is electrically connected to the sensing line and the common lines. The compensation circuit generates a compensation signal for all the common lines according to a coupling signal induced by the parasitic capacitor between the first data line and the sensing line so as to restrain ripple of the common voltage.

The present invention provides a display including a display panel and a compensation circuit. The display panel includes a plurality of common lines for transmitting a common voltage, a plurality of scan lines, a plurality of data lines disposed substantially perpendicular to the scan lines, a plurality of pixels arranged in an array and each electrically connected to the corresponding data line, scan line, and common line, a first sensing line crossing over at least one first data line among the data lines, and a second sensing line crossing over at least one second data line among the data lines. A first parasitic capacitor is formed between the first data line and the first sensing line. A second parasitic capacitor is formed between the second data line and the second sensing line. The compensation circuit is electrically connected to the first sensing line, the second sensing line, and the common lines. The compensation circuit generates a compensation signal for all the common lines according to a first coupling signal and a second coupling signal respectively induced by the first parasitic capacitor and the second parasitic capacitor, so as to restrain ripple of the common voltage.

The present invention further provides a display panel including a plurality of common lines for transmitting a common voltage, a plurality of scan lines, a plurality of data lines disposed substantially perpendicular to the scan lines, a plurality of pixels arranged in an array and each electrically connected to the corresponding data line, scan line, and common line, and a sensing line crossing over at least one first data line among the data lines. A parasitic capacitor is formed between the first data line and the sensing line, and the parasitic capacitor induces a coupling signal. The sensing line, the scan lines, and the data lines are formed on a substrate, and the coupling signal is transmitted through the sensing line.

As described above, in the present invention, at least one sensing line that crosses over all the data lines is disposed inside or outside a display area of a display panel. Coupling signals induced when the data signals respectively received by the data lines are in transient are sensed by using this sensing line through the parasitic capacitance effect. A compensation circuit performs signal processing on these coupling signals to obtain a compensation signal reverse to the coupling signals and provides the compensation signal to the common lines. Thereby, ripple of the common voltage can be effectively restrained, and accordingly the image display quality can be improved.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a diagram of a conventional liquid crystal display (LCD) panel in a tri-gate driving structure.

FIG. 1B is a diagram illustrating the ripple of a common voltage Vcom.

FIG. 2 is a diagram of a display according to an embodiment of the present invention.

FIG. 3A is a diagram of a display panel according to an embodiment of the present invention, and FIG. 3B is a layout diagram of the display panel in FIG. 3A.

FIG. 4A is a diagram of a display panel according to another embodiment of the present invention, and FIG. 4B is a layout diagram of the display panel in FIG. 4A.

FIG. 5 is a diagram of a compensation circuit according to an embodiment of the present invention.

FIG. 6 is a diagram of a compensation signal, a coupling signal, and a common voltage according to an embodiment of the present invention.

FIGS. 7A, 7B, 8A, and 8B are respectively a diagram of a display panel according to another embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

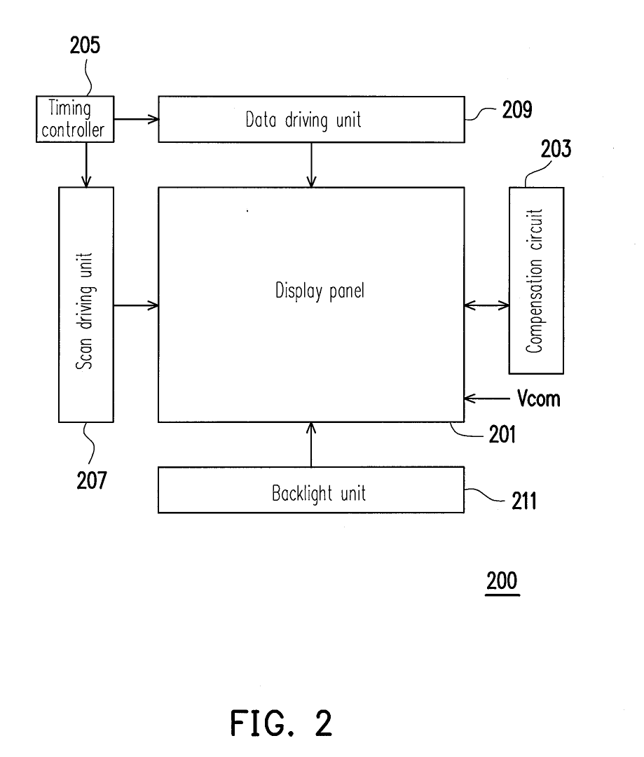

FIG. 2 is a diagram of a display 200 according to an embodiment of the present invention. Referring to FIG. 2, the display 200 may be a liquid crystal display (LCD), and which includes a display panel 201, a compensation circuit 203, a timing controller 205, a scan driving unit 207, a data driving unit 209, and a backlight unit 211. In the present embodiment, the display panel 201 displays an image. The backlight unit 211 provides a light source to the display panel 201. The timing controller 205 controls the operations of the scan driving unit 207 and the data driving unit 209 so that the scan driving unit 207 and the data driving unit 209 respectively output scan signals and data signals for driving the display panel 201.

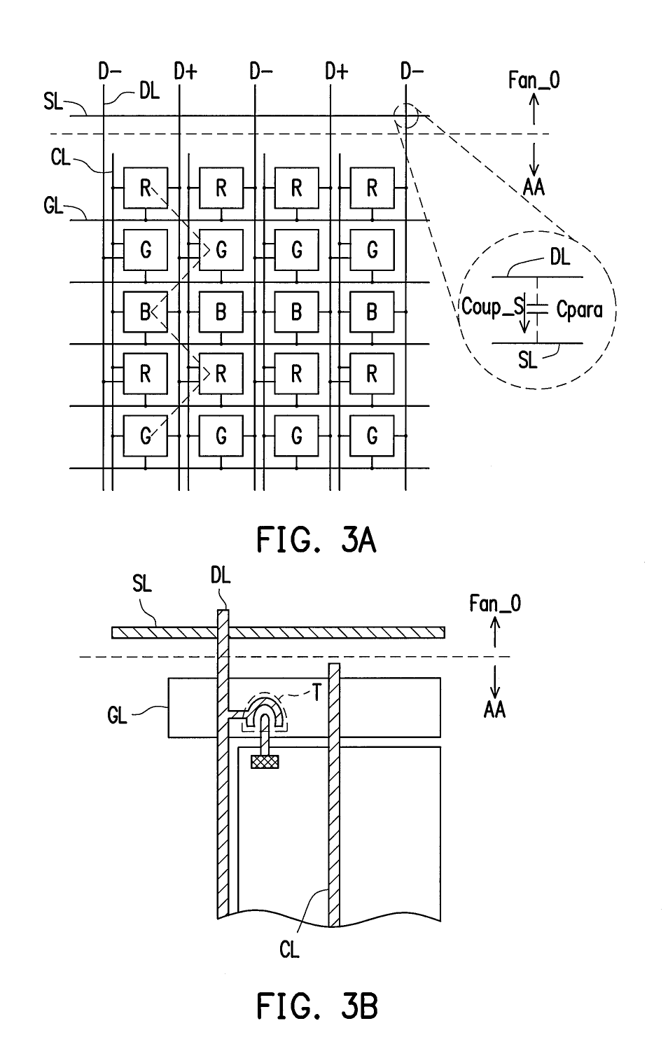

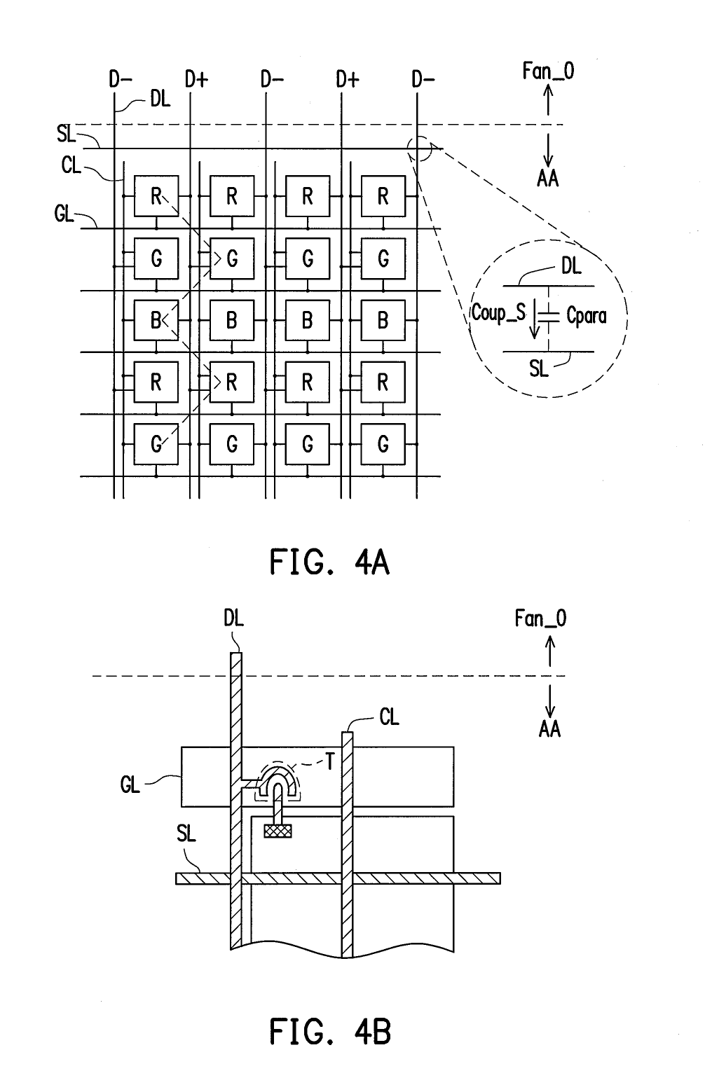

FIG. 3A is a diagram of a display panel 201 according to an embodiment of the present invention, and FIG. 3B is a layout diagram of the display panel 201 in FIG. 3A. FIG. 4A is a diagram of a display panel 201 according to another embodiment of the present invention, and FIG. 4B is a layout diagram of the display panel 201 in FIG. 4A. Referring to FIG. 3A to FIG. 4B, the display panel 201 includes a plurality of common lines CL for transmitting a common voltage Vcom, a plurality of scan lines GL, a plurality of data lines DL disposed substantially perpendicular to the scan lines GL, a plurality of pixels R, G, and B arranged in an array and each electrically connected to the corresponding data line DL, scan line GL, and common line CL, and a sensing line SL crossing over all the data lines DL. It should be mentioned that the common lines CL, the scan lines GL, the data lines DL, and the sensing line SL are all formed on the same substrate, such as the pixel array substrate of the display panel 201.

In the present embodiment, a parasitic capacitor Cₚₐᵣₐ is formed between each data line DL and the sensing line SL, and the sensing line SL is disposed outside a display area AA (i.e., a fan out area Fan_O) of the display panel 201, as shown in FIG. 3A and FIG. 3B. Or, the sensing line SL may also be disposed inside the display area AA of the display panel 201, as shown in FIG. 4A and FIG. 4B.

As shown in FIG. 3A and FIG. 4A, the active devices T (i.e., thin film transistors (TFTs)) electrically connected to the same data line are alternatively arranged at both sides of the data line along the column direction. Thus, the pixels for writing data signals through the same data line are arranged in a zigzag pattern. Accordingly, the data driving unit 209 can drive the display panel 201 through column inversion, so as to reduce the power consumption and the number of data driving chips (not shown) used in the data driving unit 209.

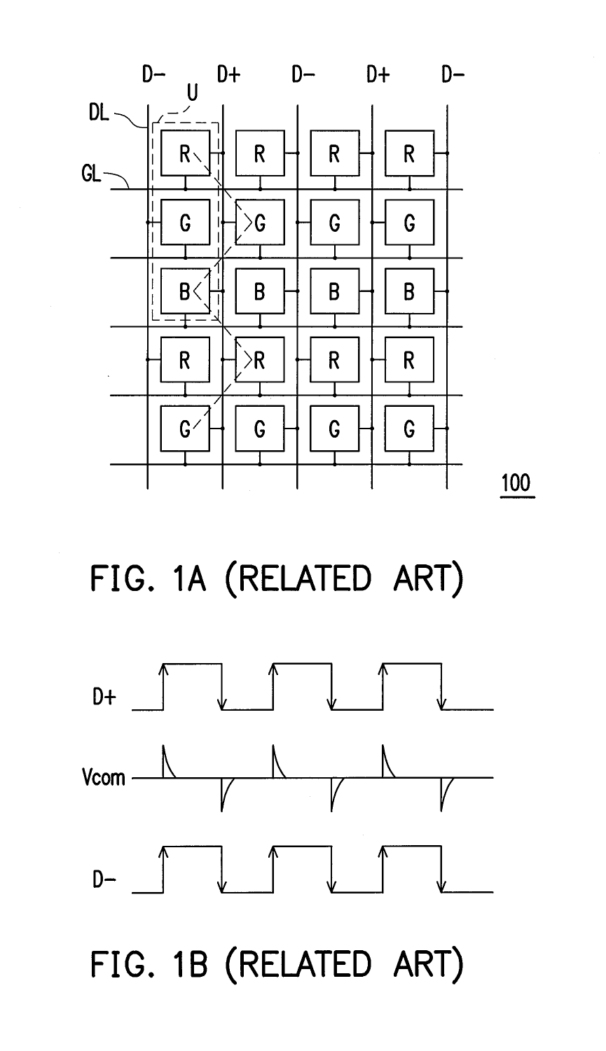

However, when the (for example, twist nematic (TN)) display panel 201 is driven through column inversion and accordingly presents an alternate black and white pattern or presents a vertical stripe pattern (i.e. V stripe pattern), because the positive data signal (D+) and the negative data signal (D−) transmitted on adjacent two data lines have the same coupling direction and parasitic capacitors exist between the data lines DL and the scan lines GL and between the scan lines GL and the common lines CL for transmitting the common voltage Vcom, coupling signals are induced by the parasitic capacitors between the data lines DL and the scan lines GL and between the scan lines GL and the common lines CL when the data signals D received by the data lines DL are in transient. As a result, ripple (as shown in FIG. 1B) is produced on the common voltage Vcom in response to such coupling signals, and the image display quality is affected.

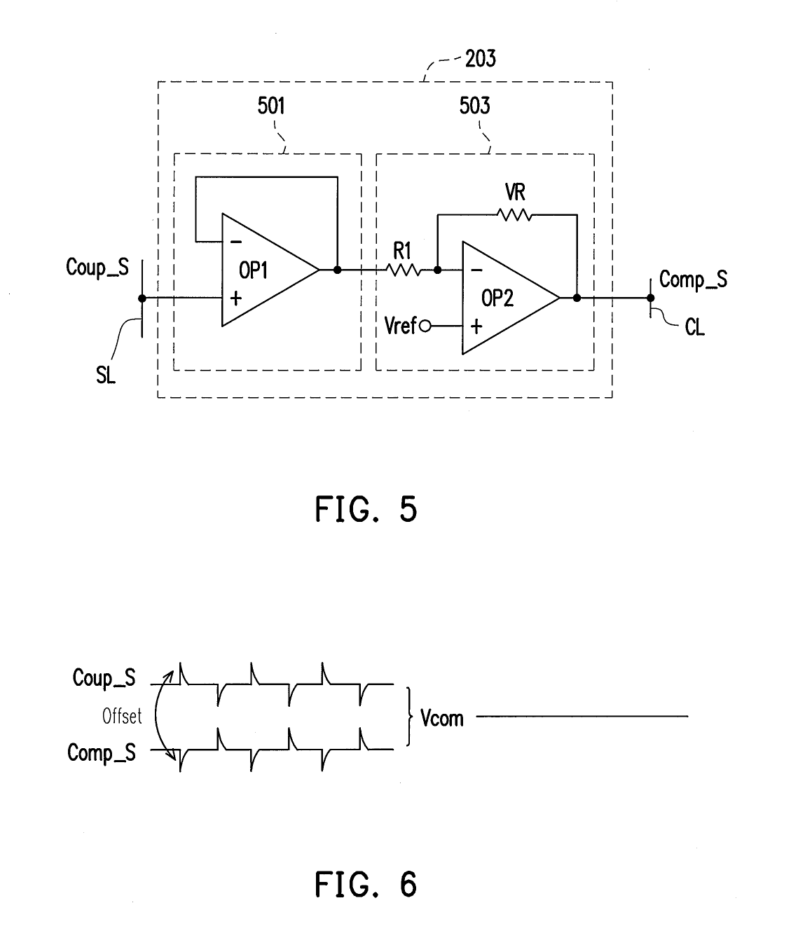

In order to resolve foregoing problem effectively, in the present embodiment, the ripple of the common voltage Vcom in the display panel 201 is restrained by using the compensation circuit 203, so as to improve the image display quality. FIG. 5 is a diagram of a compensation circuit 203 according to an embodiment of the present invention. Referring to FIG. 5, the compensation circuit 203 is electrically connected to the sensing line SL and the common lines CL. Besides, the compensation circuit 203 generates a compensation signal Comp_S for all the common lines CL according to coupling signals Coup_S (considered noises in the common voltage Vcom herein) induced by the parasitic capacitors Cₚₐᵣₐ between the data lines DL and the sensing line SL, so as to restrain the ripple of the common voltage Vcom.

To be specific, the compensation circuit 203 includes a signal enhancement unit 501 and an amplification unit 503. The signal enhancement unit 501 is electrically connected to the sensing line SL for receiving and enhancing the coupling signals Coup_S. The amplification unit 503 is electrically connected to the signal enhancement unit 501 and the common lines CL for receiving and reversely amplifying the coupling signals Coup_S output by the signal enhancement unit 501, so as to obtain the compensation signal Comp_S for the common lines CL.

In the present embodiment, the signal enhancement unit 501 includes an operational amplifier OP1. The non-inverting input terminal of the operational amplifier OP1 is electrically connected to the sensing line SL for receiving the coupling signals Coup_S, and the inverting input terminal and the output terminal of the operational amplifier OP1 are coupled with each other for outputting the coupling signals Coup_S. As shown in FIG. 5, the signal enhancement unit 501 is a voltage follower and which enhances the intensity of the coupling signals Coup_S transmitted through the sensing line SL.

In addition, the amplification unit 503 includes a resistor R1, an operational amplifier OP2, and a variable resistor VR. The first end of the resistor R1 is electrically connected to the output terminal of the operational amplifier OP1, and the second end of the resistor R1 is electrically connected to the inverting input terminal of the operational amplifier OP2. The non-inverting input terminal of the operational amplifier OP2 receives a reference voltage Vref, and the output terminal of the operational amplifier OP2 is electrically connected to the common lines CL for outputting the compensation signal Comp_S. The variable resistor VR is connected between the inverting input terminal and the output terminal of the operational amplifier OP2 in parallel. As shown in FIG. 5, the amplification unit 503 is an inverting amplification circuit, and the gain thereof can be adjusted according to the actual design requirement by adjusting the resistances of the resistor R1 and the variable resistor VR.

As described above, the coupling signals Coup_S are only induced by the parasitic capacitors Cₚₐᵣₐ between the data lines DL and the sensing line SL when the data signals D received by the data lines DL are in transient, and the coupling signals Coup_S are all transmitted to the compensation circuit 203 through the sensing line SL. Thus, the compensation circuit 203 can enhance and reversely amplify the coupling signals Coup_S induced by the parasitic capacitors Cₚₐᵣₐ between the data lines DL and the sensing line SL, so as to generate the compensation signal Comp_S reverse to the coupling signals Coup_S for the common lines CL. In addition, the original noises in the common voltage Vcom are offset by the compensation signal Comp_S (as shown in FIG. 6) so that the ripple of the common voltage Vcom can be effectively restrained and accordingly the image display quality can be improved.

In the present embodiment, signal coupling occurs when the data signals are in transient. Thus, a sensing line crossing over all the data lines is disposed in the pixel array of the display panel for specially sensing the coupling signals induced when the data signals are in transient. Accordingly, when the data signals are in transient, the coupling signals are transmitted to the compensation circuit to be processed through the parasitic capacitance effect. After that, the compensation circuit provides a compensation signal to the common lines in the pixel array for transmitting the common voltage. Thus, noises coupled to the common voltage when the data signals are in transient are offset by the compensation signal, so that the ripple of the common voltage is effectively restrained.

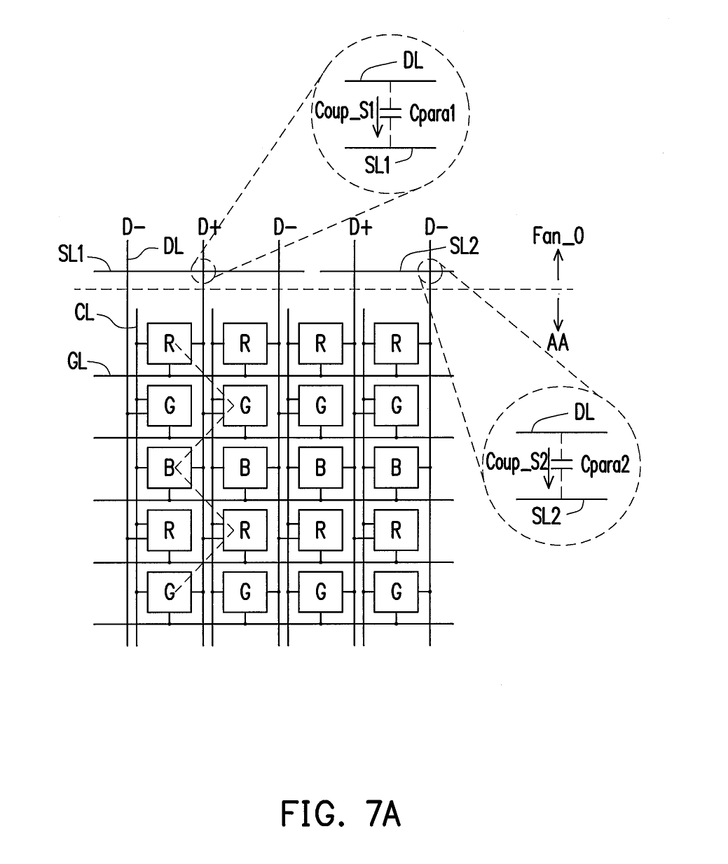

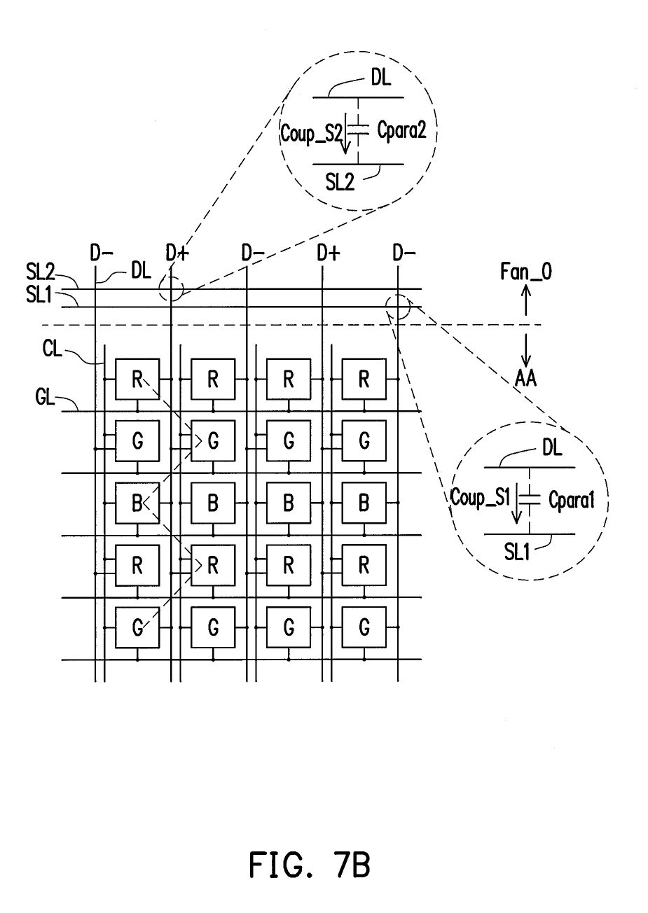

Even though foregoing embodiment is described with a single sensing line SL crossing over all the data lines DL, the present invention is not limited thereto. FIGS. 7A and 7B are respectively a diagram of a display panel 201 according to another embodiment of the present invention. The difference between FIG. 7A and FIG. 3A is that two sensing lines (i.e., the sensing lines SL1 and SL2) are disposed inside the fan out area Fan_O in FIG. 7A, and one of the two sensing lines SL1 and SL2 crosses over a part of the data lines DL while the other one crosses over the rest of the data lines DL. Additionally, the difference between FIG. 7B and FIG. 3A is that two sensing lines (i.e., the sensing lines SL1 and SL2) are disposed inside the fan out area Fan_O in FIG. 7B, and these two sensing lines SL1 and SL2 respectively cross over all the data lines DL.

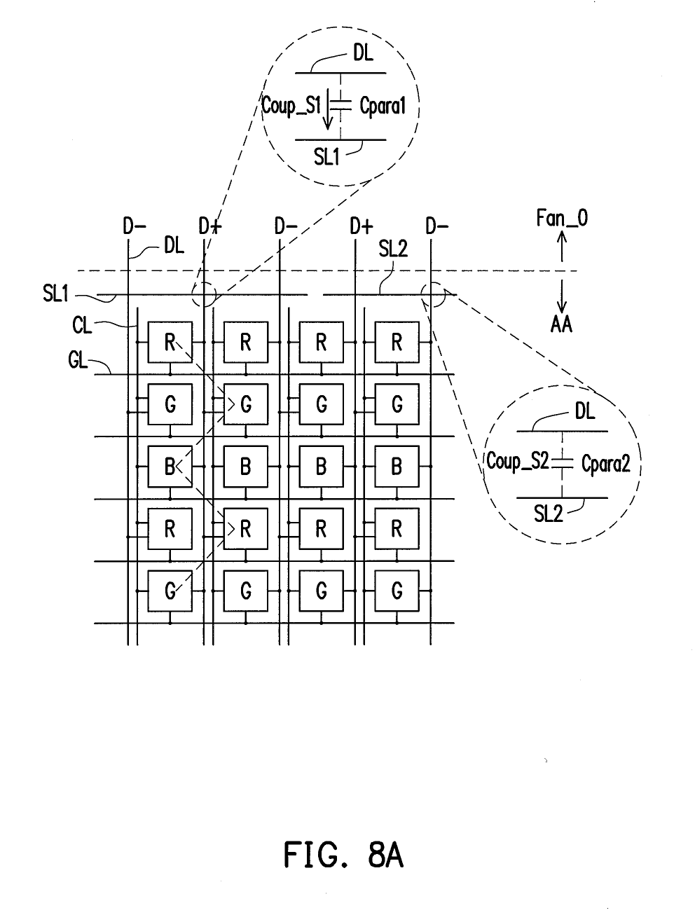

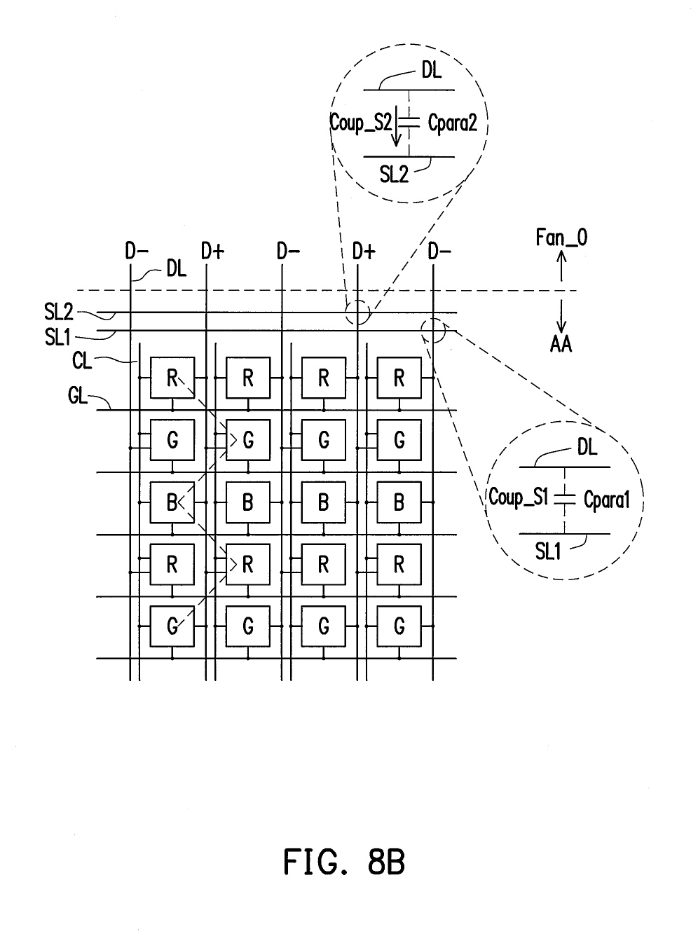

Similarly, FIGS. 8A and 8B are respectively a diagram of a display panel 201 according to another embodiment of the present invention. The difference between FIG. 8A and FIG. 4A is that two sensing lines (i.e., the sensing lines SL1 and SL2) are disposed inside the display area AA in FIG. 8A, and one of the two sensing lines SL1 and SL2 crosses over a part of the data lines DL while the other one crosses over the rest of the data lines DL. Additionally, the difference between FIG. 8B and FIG. 4A is that two sensing lines (i.e., the sensing lines SL1 and SL2) are disposed inside the display area AA in FIG. 8B, and these two sensing lines SL1 and SL2 respectively cross over all the data lines DL.

It should be mentioned herein that the common lines CL, the scan lines GL, the data lines DL, and the sensing lines SL1 and SL2 are all formed on the same substrate, such as the pixel array substrate of the display panel 201. In addition, parasitic capacitors Cₚₐᵣₐ₁ are formed between the sensing line SL1 and the data lines DL, and coupling signals Coup_S1 are induced by the parasitic capacitors Cₚₐᵣₐ₁. Besides, parasitic capacitors Cₚₐᵣₐ₂ are formed between the sensing line SL2 and the data lines DL, and coupling signals Coup_S2 are induced by the parasitic capacitors Cₚₐᵣₐ₂.

In the embodiments illustrated in FIGS. 7A, 7B, 8A, and 8B, the coupling signals Coup_S1 are only induced by the parasitic capacitors Cₚₐᵣₐ₁ between the data lines DL and the sensing line SL1 when the data signals D received by the data lines DL are in transient, and the coupling signals Coup_S1 are all transmitted to the compensation circuit 203 through the sensing line SL1. Similarly, the coupling signals Coup_S2 are only induced by the parasitic capacitors Cₚₐᵣₐ₂ between the data lines DL and the sensing line SL2 when the data signals D received by the data lines DL are in transient, and the coupling signals Coup_S2 are all transmitted to the compensation circuit 203 through the sensing line SL2.

Accordingly, the compensation circuit 203 enhances and reversely amplifies the coupling signals Coup_S1 and Coup_S2 induced by the parasitic capacitors Cₚₐᵣₐ₁ and Cₚₐᵣₐ₂ between the data lines DL and the sensing lines SL1 and SL2 to generate the compensation signal Comp_S reverse to the coupling signals Coup_S1 and Coup_S2 for the common lines CL. Consequently, the original noises in the common voltage Vcom are offset by the compensation signal Comp_S, so that the ripple of the common voltage Vcom can be effectively restrained and the image display quality can be improved.

It should be mentioned herein that the sensing lines in foregoing embodiments can be disposed inside or outside the display area AA or the fan out area Fan_O by any means as long as they cross over all the data lines DL. Thereby, the present invention is not limited to the patterns illustrated in the drawings accompanying the embodiments described above.

As described above, in the present invention, at least one sensing line crossing over all the data lines is disposed inside or outside a display area of a display panel, and the sensing lines, the scan lines, and the data lines are all formed on the same substrate. The coupling signals induced when the data signals respectively received by the data lines are in transient are sensed by these sensing lines through the parasitic capacitance effect. A compensation circuit processes the coupling signals to obtain a compensation signal reverse to the coupling signals and sends the compensation signal to the common lines. Thereby, the ripple of the common voltage can be effectively restrained and the image display quality can be improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display, comprising:
a display panel, comprising:
a plurality of common lines, for transmitting a common voltage;
a plurality of scan lines;
a plurality of data lines, disposed substantially perpendicular to the scan lines;
a plurality of pixels, each of the pixel electrically connected to the corresponding data line, the corresponding scan line, and the corresponding common line, wherein the pixels are arranged in an array; and
a sensing line, crossing over at least a first data line among the data lines, wherein a parasitic capacitor is formed between the first data line and the sensing line; and
a compensation circuit, electrically connected to the sensing line and the common lines, wherein the compensation circuit generates a compensation signal for the common lines according to a coupling signal induced by the parasitic capacitor between the first data line and the sensing line, so as to restrain a ripple of the common voltage.

2. The display according to claim 1, wherein the coupling signal is transmitted to the compensation circuit through the sensing line, and the compensation circuit performs a signal processing on the coupling signal to generate the compensation signal,
wherein the coupling signal is generated when a data signal received by the first data line is in transient, and the coupling signal and the compensation signal are reverse to each other.

3. The display according to claim 2, wherein the compensation circuit comprises:
a signal enhancement unit, electrically connected to the sensing line, for receiving and enhancing the coupling signal; and
an amplification unit, electrically connected to the signal enhancement unit and the common lines, for receiving and reversely amplifying the coupling signal output by the signal enhancement unit so as to obtain the compensation signal for the common lines.

4. The display according to claim 3, wherein the signal enhancement unit comprises:
a first operational amplifier, having a non-inverting input terminal electrically connected to the sensing line for receiving the coupling signal, and an inverting input terminal and an output terminal coupled with each other for outputting the coupling signal.

5. The display according to claim 4, wherein the amplification unit comprises:
a resistor, having a first end electrically connected to the output terminal of the first operational amplifier;
a second operational amplifier, haivng an inverting input terminal electrically connected to a second end of the resistor, a non-inverting input terminal for receiving a reference voltage, and an output terminal electrically connected to the common lines for outputting the compensation signal; and
a variable resistor, connected between the inverting input terminal and the output terminal of the second operational amplifier in parallel.

6. The display according to claim 1, wherein the sensing line is disposed inside or outside a display area of the display panel.

7. The display according to claim 1, wherein the sensing line further crosses over the rest of the data lines.

8. The display according to claim 1, wherein the sensing line, the scan lines, and the data lines are all formed on a substrate.

9. A display, comprising:
a display panel, comprising:
a plurality of common lines, for transmitting a common voltage;
a plurality of scan lines;
a plurality of data lines, disposed substantially perpendicular to the scan lines;
a plurality of pixels, each of the pixels electrically connected to the corresponding data line, the corresponding scan line, and the corresponding common line, wherein the pixels are arranged in an array;
a first sensing line, crossing over at least a first data line among the data lines, wherein a first parasitic capacitor is formed between the first data line and the first sensing line; and
a second sensing line, crossing over at least a second data line among the data lines, wherein a second parasitic capacitor is formed between the second data line and the second sensing line; and
a compensation circuit, electrically connected to the first sensing line, the second sensing line, and the common lines, wherein the compensation circuit generates a compensation signal for the common lines according to a first coupling signal and a second coupling signal respectively induced by the first parasitic capacitor and the second parasitic capacitor, so as to restrain a ripple of the common voltage.

10. The display according to claim 9, wherein the first coupling signal and the second coupling signal are transmitted to the compensation circuit respectively through the first sensing line and the second sensing line, and the compensation circuit performs a signal processing on the first coupling signal and the second coupling signal to generate the compensation signal,
wherein the first coupling signal and the second coupling signal are generated when a data signal respectively received by the first data line and the second data line is in transient, and the first coupling signal and the second coupling signal are reverse to the compensation signal.

11. The display according to claim 10, wherein the compensation circuit comprises:
a signal enhancement unit, electrically connected to the first sensing line and the second sensing line, for receiving and amplifying the first coupling signal and the second coupling signal; and
an amplification unit, electrically connected to the signal enhancement unit and the common lines, for receiving and reversely amplifying the first coupling signal and the second coupling signal output by the signal enhancement unit, so as to obtain the compensation signal for the common lines.

12. The display according to claim 9, wherein the first sensing line and/or the second sensing line are disposed inside or outside a display area of the display panel.

13. The display according to claim 9, wherein the first sensing line and/or the second sensing line further cross over the rest of the data lines.

14. The display according to claim 9, wherein the first sensing line, the second sensing line, the scan lines, and the data lines are all formed on a substrate.

15. The display according to claim 13, wherein the first sensing line and the second sensing line are disposed inside or outside the display area of the display panel.

16. A display panel, comprising:
a plurality of common lines, for transmitting a common voltage;
a plurality of scan lines;
a plurality of data lines, disposed substantially perpendicular to the scan lines;
a plurality of pixels, respectively electrically connected to the corresponding data lines, the corresponding scan lines, and the corresponding common lines, wherein the pixels are arranged in an array; and
a sensing line, crossing over at least a first data line among the data lines, wherein a parasitic capacitor is formed between the first data line and the sensing line, the parasitic capacitor induces a coupling signal, the sensing line, the scan lines, and the data lines are all formed on a substrate, and the coupling signal is transmitted through the sensing line.

17. The display panel according to claim 16, wherein the coupling signal is transmitted to a compensation circuit through the sensing line.
